(19) United States
(12) Patent Application Publication
(10) Pub. No.: US 2013/0182453 A1
(43) Pub. Date: Jul. 18, 2013

(54) Vehicle Headlamp

(71) Applicants: Joji Masuda, Tokyo (JP); Youichi Takano, Kawaguchi-shi (JP); Masato Ito, Kisarazu-shi (JP)

(72) Inventors: Joji Masuda, Tokyo (JP); Youichi Takano, Kawaguchi-shi (JP); Masato Ito, Kisarazu-shi (JP)

(73) Assignee: FALTEC CO., LTD., Kanagawa (JP)

(21) Appl. No.: 13/823,390

(22) PCT Filed: Sep. 16, 2011
(86) PCT No.: PCT/JP2011/071215

§ 371 Date: Mar. 14, 2013

(30) Foreign Application Priority Data
Sep. 17, 2010 (JP) JP2010209502

(51) Int. Cl. F21V 8/00

(52) U.S. Cl. CPC G02B 6/0096
USPC 362/511

(57) ABSTRACT

A vehicle headlamp includes a transparent cover, a lamp body, and a illumination optical system which is accommodated in the lamp body and projects light to a predetermined illumination region in front of a vehicle via the transparent cover, wherein the illumination optical system includes a semiconductor light-emitting element in which an optical axis is configured to be directed toward the transparent cover, and a light beam guide tube which is provided between the semiconductor light-emitting element and the transparent cover and defines the illumination region by surrounding the optical axis.

### TECHNICAL FIELD

The present invention relates to a vehicle headlamp.

Priority is claimed on Japanese Patent Application No. 2010-209502, filed Sep. 17, 2010, the content of which is incorporated herein by reference.

### BACKGROUND ART

A vehicle headlamp is configured to project light to a predetermined illumination region of the front of a vehicle from the viewpoint of traveling safety. The illumination region is determined by the specification of a vehicle or by predetermined regulations, and the illumination optical system of the vehicle headlamp is optically designed so as to project light to the determined illumination region. In Japanese Unexamined Patent Application, First Publication No. 2007-207528, and Japanese Unexamined Patent Application, First Publication No. 2010-108637, vehicle headlamps are disclosed which include a light source, a lens, a reflector, and the like as the illumination optical system.

However, in the optical design of the related art, there is a problem in that much time and expenses are spent. Specifically, it is necessary to perform optical design such as alignment of focus positions of a light source, a lens, and a reflector and convergence or diffusion due to the lens. Moreover, until a product is developed, since the optical design is repeated from several times to tens of times and trial production and experiments are performed each time, there is a problem in that much time and expenses are spent until the development is completed.

### SUMMARY OF THE INVENTION

The present invention is made in consideration of the above-described problems. An object of the present invention is to provide a vehicle headlamp capable of achieving a predetermined performance due to ease of optical design and of decreasing an expense burden due to a short period of trial production and experiments.

In order to achieve the object, the following configurations are adopted. A vehicle headlamp according to an aspect of the present invention includes: a transparent cover; a lamp body; and an illumination optical system which is accommodated in the lamp body and project light to a predetermined illumination region in front of a vehicle via the transparent cover. The illumination optical system includes a semiconductor light-emitting element in which an optical axis is configured to be directed toward the transparent cover, and a light beam guide tube which is provided between the semiconductor light-emitting element and the transparent cover and defines the illumination region by surrounding the optical axis.

By adopting this configuration, light having high directivity which is emitted from the semiconductor light-emitting element is guided by the light beam guide tube disposed around the optical axis, and the light is projected to a predetermined illumination region in front of the vehicle via the transparent cover. The illumination region is defined by the light beam guide tube. In the light beam guide tube, since the shape is simple and focus alignment is not required as it is in the related art, the degrees of freedom in the disposition increase, and the design change is easily performed. Furthermore, since the design of the opening shape of the light beam guide tube is changed, the irradiation direction, the irradiation range, and the amount of light can be adjusted, and thus, a predetermined required performance can be easily achieved.

Moreover, the vehicle headlamp may be configured as follows. The light beam guide tube further includes a light lead-in port provided on a side in which the semiconductor light-emitting element is disposed, and a light lead-out port provided on a side in which the transparent cover is disposed. At least a portion of the light lead-in port and at least a portion of the light lead-out port are disposed so as to overlap each other in a direction in which the optical axis extends.

By adopting this configuration, since at least a portion of the light lead-in port and at least a portion of the light lead-out port are disposed so as to overlap each other in the direction in which the optical axis extends, direct light having a large amount of light emitted from the semiconductor light-emitting element is introduced to the transparent cover, and is projected to the illumination region.

Furthermore, the vehicle headlamp may be configured as follows. The light beam guide tube includes a shape in which an opening area gradually increases in directions except for the upper portion from the light lead-in port toward the light lead-out port.

By adopting this configuration, even though light emitted from the semiconductor light-emitting element is radiated and diffused, the opening area of the light beam guide tube gradually increases from the light lead-in port toward the light lead-out port, therefore the light which collides with the inner surface of the light beam guide tube is decreased due to the radiation and diffusion, and light losses due to the collision can be decreased. Moreover, since the light beam guide tube gradually increases in size in the directions except for the upper portion, the amount of light of the upper portion is decreased, and thus, it is possible to eliminate glare for an oncoming vehicle.

Furthermore, the vehicle headlamp may be configured as follows. The vehicle headlamp further includes a position adjustment mechanism which adjusts a position of the light lead-out port.

By adopting this configuration, even after the light beam guide tube is assembled, the irradiation direction can be adjusted by adjusting the position of the light lead-out port.

Moreover, the vehicle headlamp may be configured as follows. A light reflection surface is provided on an inner surface side of the light beam guide tube.

By adopting this configuration, since the light which collides with the inner surface of the light beam guide tube due to the radiation and diffusion is reflected by the light reflection surface and is finally lead out from the light lead-out port, the emitted light can be projected to the irradiation region without waste.

Moreover, the vehicle headlamp may be configured as follows. The light reflection surface has curvature.

By adopting this configuration, the light reflection surface has curvature, and thus, a diffusion range of the reflected light can be controlled.

Moreover, the vehicle headlamp may be configured as follows. In the inner surface side of the light beam guide tube, the light reflection surface provided on the upper portion and the light reflection surface provided on the lower portion include light reflectivities which are different from each other.

By adopting this configuration, the light reflected by the upper light reflection surface and the light reflected by the lower light reflection surface are prevented from and interfering with each other, and the illumination region can be uniformly illuminated.

Furthermore, the vehicle headlamp may be configured as follows. The optical axis of the semiconductor light-emitting element is configured to be directed downward with respect to a direction along the horizontal surface.

By adopting this configuration, since the optical axis of the semiconductor light-emitting element is configured to be directed downward with respect to the direction along the horizontal surface, direct light is projected to the illumination region on a road surface, and thus, the amount of light can be effectively used.

Moreover, the vehicle headlamp may be configured as follows. A notched configuration, which is notched at a predetermined distance toward the other end of a side in which the semiconductor light-emitting element is disposed, is provided at a lower portion of one end of a side in which the transparent cover of the light beam guide tube is disposed.

By adopting this configuration, since the lower side of the light beam guide tube is relatively shorter with respect to the upper side thereof, the amount of the light toward the lower side can increase while the light toward the upper side is restricted.

Furthermore, the vehicle headlamp may be configured as follows. The notched configuration is provided in a pair with an interval therebetween in a left-right direction in which the optical axis is interposed.

By adopting this configuration, the amount of light in the illumination region in the left-right direction can increase while the amount of light of the illumination region immediately below the front of the vehicle is suppressed.

Moreover, the vehicle headlamp may be configured as follows. The light beam guide tube includes a light lead-in port provided on a side in which the semiconductor light-emitting element is disposed, and a light lead-out port provided on a side in which the transparent cover is disposed. In addition, the light lead-in port is disposed with a distance from the semiconductor light-emitting element.

By adopting this configuration, since light is leaked from the gap between the light lead-in port and the semiconductor light-emitting element and not only the inner portion of the light beam guide tube but also the outer portion thereof is illuminated, the appearance can be improved.

Moreover, the vehicle headlamp may be configured as follows. The light beam guide tube includes a light lead-in port provided on a side in which the semiconductor light-emitting element is disposed, and a light lead-out port provided on a side in which the transparent cover is disposed. Furthermore, a second light lead-out port, which guides a portion of the light introduced to the inner portion via the light lead-in port to the outside, is formed in a body of the light beam guide tube.

By adopting this configuration, since light is positively leaked from the second light lead-out port which is formed on the body of the light beam guide tube, the appearance can be improved.

According to the present invention, a vehicle headlamp capable of achieving a predetermined performance due to ease of optical design and of decreasing an expense burden due to a short period of trial production and experiments can be obtained.

### BRIEF DESCRIPTION OF THE DRAWINGS

FIG. 1 is a perspective view showing a passenger car in which a fog lamp according to an embodiment of the present invention is provided.

FIG. 2 is a cross-section view showing a mounting structure of the fog lamp according to the embodiment.

FIG. 3 is a perspective view showing the fog lamp according to the embodiment.

FIG. 4 is an exploded perspective view showing the fog lamp according to the embodiment.

FIG. 5 is a cross-section view showing the fog lamp according to the embodiment.

FIG. 6 is an exploded cross-sectional view showing the fog lamp according to the embodiment.

FIG. 7 is a view showing directional characteristics of a LED.

FIG. 8A is a cross-sectional view taken along A-A of FIG. 6.

FIG. 8B is a cross-sectional view taken along B-B of FIG. 6.

FIG. 9A is a view showing an opening shape of a light lead-out port according to another embodiment of the present invention.

FIG. 9B is a view showing an opening shape of a light lead-out port according to another embodiment of the present invention.

FIG. 9C is a view showing an opening shape of a light lead-out port according to another embodiment of the present invention.

FIG. 9D is a view showing an opening shape of a light lead-out port according to another embodiment of the present invention.

FIG. 9B is a view showing an opening shape of a light lead-out port according to another embodiment of the present invention.

FIG. 10A is a cross-sectional view showing a fog lamp according to another embodiment of the present invention.

FIG. 10B is a cross-sectional view showing a fog lamp according to another embodiment of the present invention.

FIG. 11 is a cross-sectional view showing a fog lamp according to another embodiment of the present invention.

FIG. 12 is a front view showing a transparent cover according to another embodiment of the present invention.

FIG. 13 is a cross-sectional view showing a transparent cover according to another embodiment of the present invention.

FIG. 14 is a cross-sectional view showing a transparent cover according to another embodiment of the present invention.

FIG. 15A is a front view showing a fog lamp according to another embodiment of the present invention.

FIG. 15B is a cross-sectional view showing a fog lamp according to another embodiment of the present invention.

FIG. 16A is a front view showing a fog lamp according to another embodiment of the present invention.

FIG. 16B is a cross-sectional view showing a fog lamp according to another embodiment of the present invention.

FIG. 17 is a cross-sectional view showing a fog lamp according to another embodiment of the present invention.

FIG. 18 is a cross-sectional view showing a fog lamp according to another embodiment of the present invention.

FIG. 19 is a bottom view showing a light beam guide tube according to another embodiment of the present invention.

### DETAILED DESCRIPTION OF THE INVENTION

Next, an aspect of an embodiment of the present invention will be described with reference to the drawings. Moreover, in descriptions below, a case where the present invention is applied to a fog lamp is provided as an exemplary example.

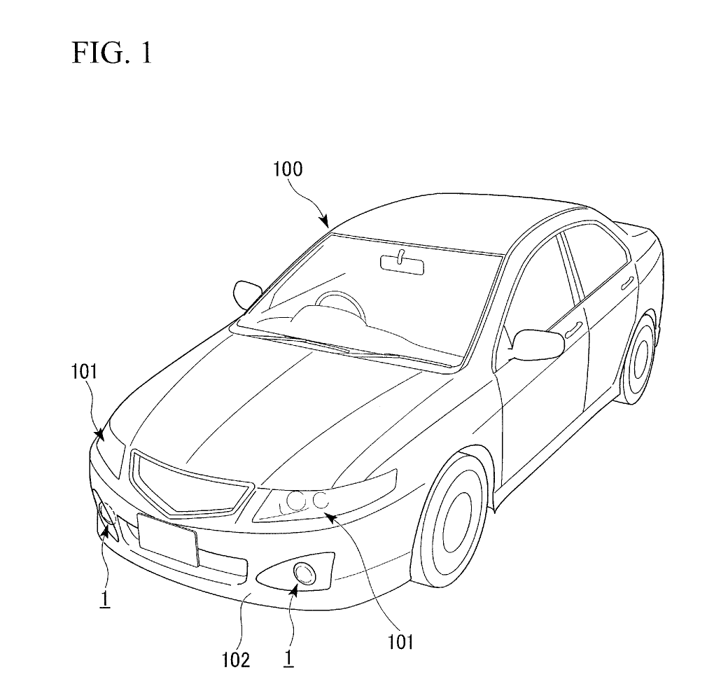

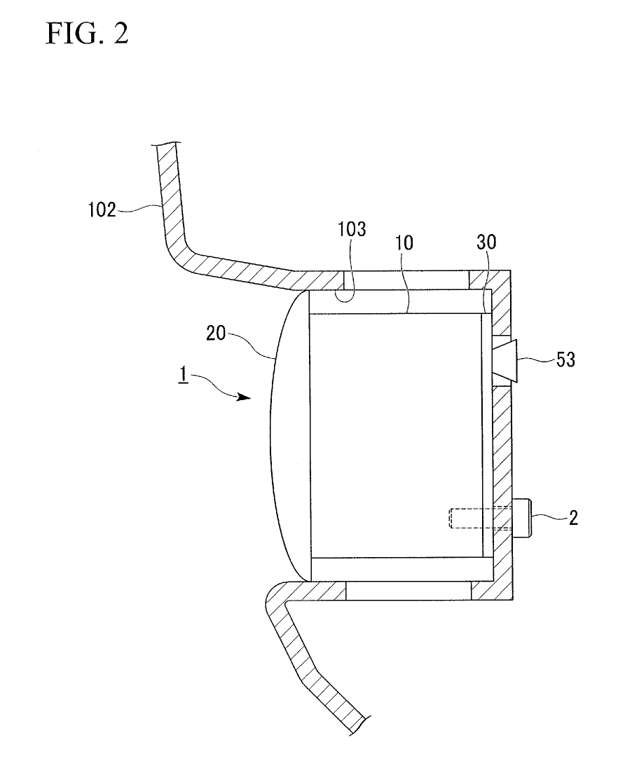

FIG. 1 is a perspective view showing a passenger car 100 in which a fog lamp 1 according to an embodiment of the present invention is provided. FIG. 2 is a cross-sectional view showing a mounting structure of the fog lamp 1 according to the embodiment.

As shown FIG. 1, in the passenger car 100 of the embodiment, a headlamp (a headlamp for traveling and a headlamp for passing each other) 101 and a fog lamp (a front fog lamp) 1 are provided as a vehicle headlamp. Moreover, the fog lamp 1 is also referred to as an auxiliary headlamp.

As shown in FIG. 2, the fog lamp 1 is inserted into a recessed portion 103 provided in a front bumper 102, and a bottom portion of the recessed portion 103 and a rear portion of the fog lamp 1 are screwed by a screw member 2, and thus, the fog lamp is mounted. Moreover, the mounting structure of the fog lamp 1 is not limited to this structure and may be appropriately changed according to the specification of the vehicle or the like.

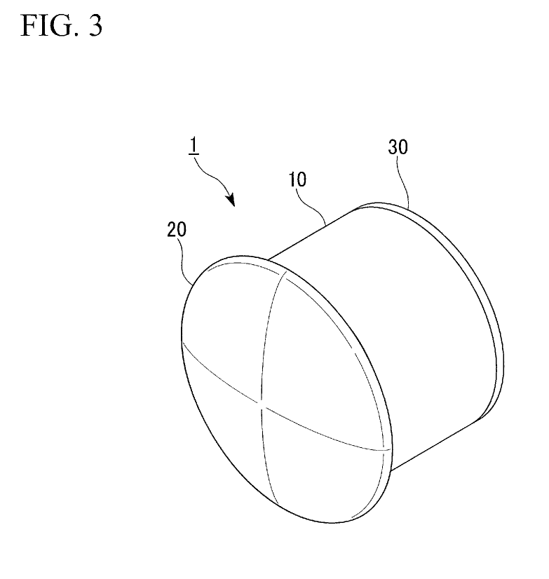

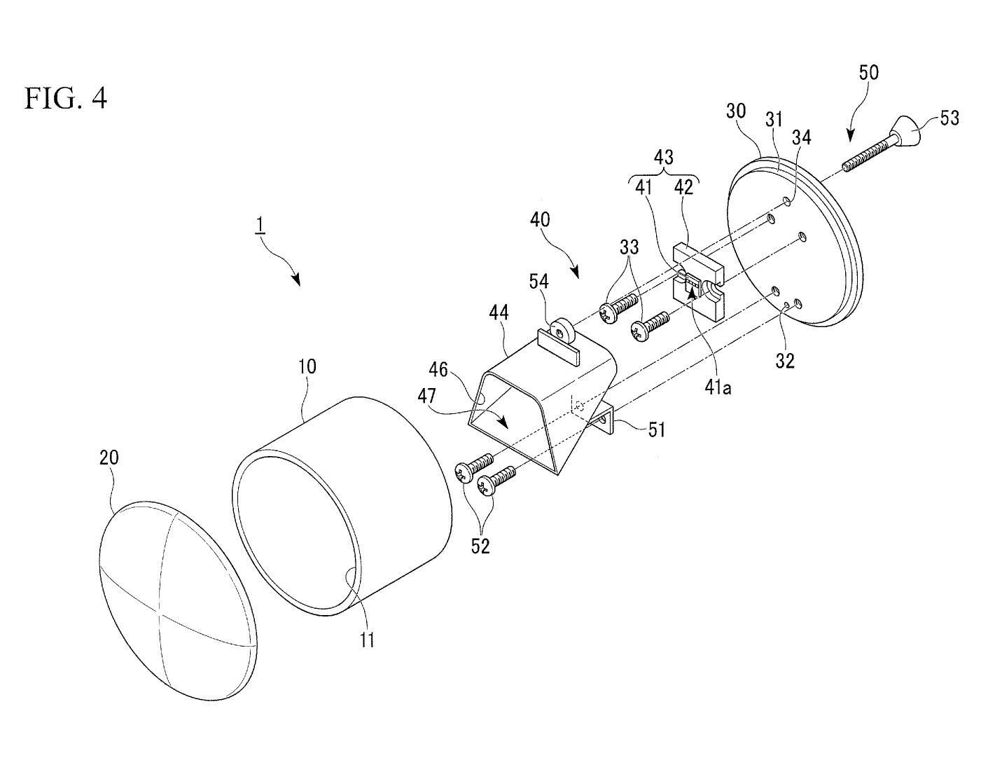

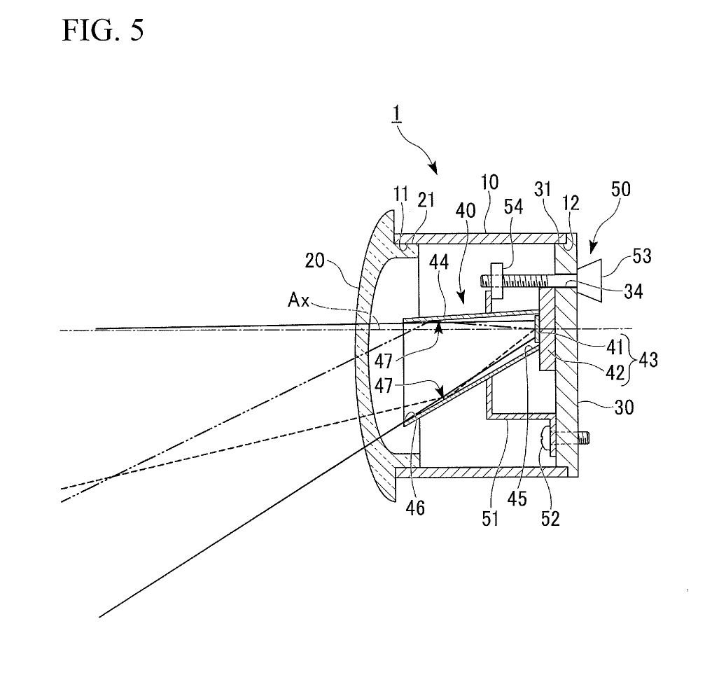

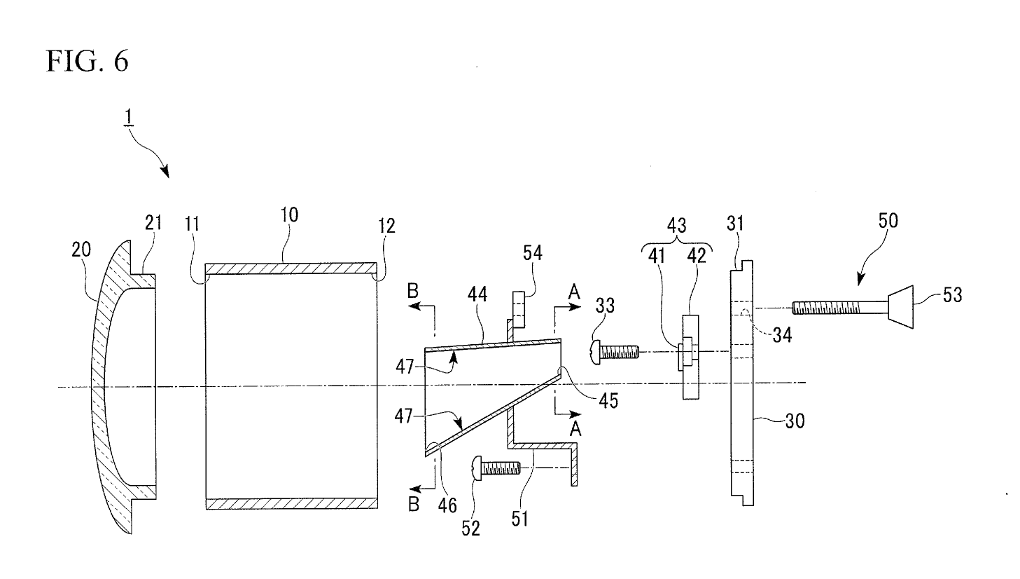

FIG. 3 is a perspective view showing the fog lamp 1 according to the embodiment. FIG. 4 is an exploded perspective view showing the fog lamp 1 according to the embodiment. FIG. 5 is a cross-section view showing the fog lamp 1 according to the embodiment. FIG. 6 is an exploded cross-sectional view showing the fog lamp 1 according to the embodiment.

As shown in the drawings, the fog lamp 1 is configured to accommodate an illumination optical system 40 in a light chamber which is formed by a lamp body 10, a transparent cover 20, and a rear cover 30.

The lamp body 10 has a tubular shape which extends in a predetermined direction. The lamp body 10 according to the embodiment is formed of an extrusion molded material. More specifically, the lamp body 10 is formed by cutting an extrusion-molded pipe material to a predetermined length. Furthermore, the lamp body 10 according to the embodiment has a round pipe shape. However, the design of the lamp body may be appropriately changed according to the specification of the vehicle to a shape such as an elliptical pipe shape or a quadrilateral pipe shape. The lamp body 10 also functions as a heat sink which relieves heat emitted from the illumination optical system 40 to the outside of the light chamber. In order to improve heat radiation performance, the lamp body 10 according to the embodiment is configured by an aluminum material which is subjected to black alumite processing. In addition, in order to improve heat radiation performance, the lamp body may be configured to be black-painted instead of the black alumite processing.

The transparent cover 20 is mounted so as to cover one end side opening 11 of the lamp body 10. The transparent cover 20 includes a fitting portion 21 which is fitted along the inner surface of the one end side opening 11. The transparent cover 20 is adhered to the lamp body 10 and is configured to prevent foreign matters (water, dust, mud, or the like) from entering into the light chamber. The transparent cover 20 is formed of a glass material, a resin material, or the like and is configured so as to project the light to in front of the vehicle.

The rear cover 30 is mounted so as to cover the other end side opening 12 of the lamp body 10. The rear cover 30 includes a fitting portion 31 which is fitted along the inner surface of the other end side opening 12. The rear cover 30 is fixed to the lamp body 10 by adherence, caulking, or a screw member (not shown). The rear body 30 is configured to support the illumination optical system 40. In addition, the rear cover 30 functions as a heat sink which relieves heat emitted from the illumination optical system 40 to the outside of the light chamber.

The rear cover 30 is formed by a heat conduction material which conducts at least a portion of the heat emitted from the illumination optical system 40 to the lamp body 10. In order to improve heat radiation performance, the rear cover 30 according to the embodiment is configured by an aluminum material which is subjected to black alumite processing. An air vent 32 (refer to FIG. 4) is formed in the rear cover 30 so that the inner portion of the light chamber is not completely sealed. According to this configuration, heat of a LED module 43 is conducted to the rear cover 30 and radiated to the outside. Moreover, the heat in the rear cover 30 is conducted to the lamp body 10 which has a wider surface area (heat radiation area) and is radiated to the outside. Thereby, it is possible to prevent luminous efficiency of the LED 41 from being decreased due to an increase in the temperature.

Moreover, a through-hole (not shown) for introducing a cable harness (not shown) which includes a power cable, which is electrically connected to the illumination optical system 40 or the like to the inside of the light chamber is formed in the lamp body 10 or the rear cover 30.

The illumination optical system 40 is configured by the LED module 43 which includes the LED (semiconductor light-emitting element) 41 and a substrate 42 and a light beam guide tube 44. The cable harness (not shown) is configured to be electrically connected to the LED 41 via the substrate 42. The LED module 43 is fixed to the rear cover 30 by a screw member 33 while interposing heat radiation grease (silicon grease in the embodiment). Moreover, as shown in FIG. 5, an optical axis Ax of the LED 41 is configured to be directed toward the transparent cover 20. Furthermore, as shown in FIG. 4, the LED 41 according to the embodiment includes light-emitting units 41a in which four rectangular light-emitting regions performing surface light emission are disposed in series in the left-right direction (horizontal direction and vehicle width direction). Here, the optical axis Ax means the central optical axis when the light-emitting units 41a are regarded as a single light source.

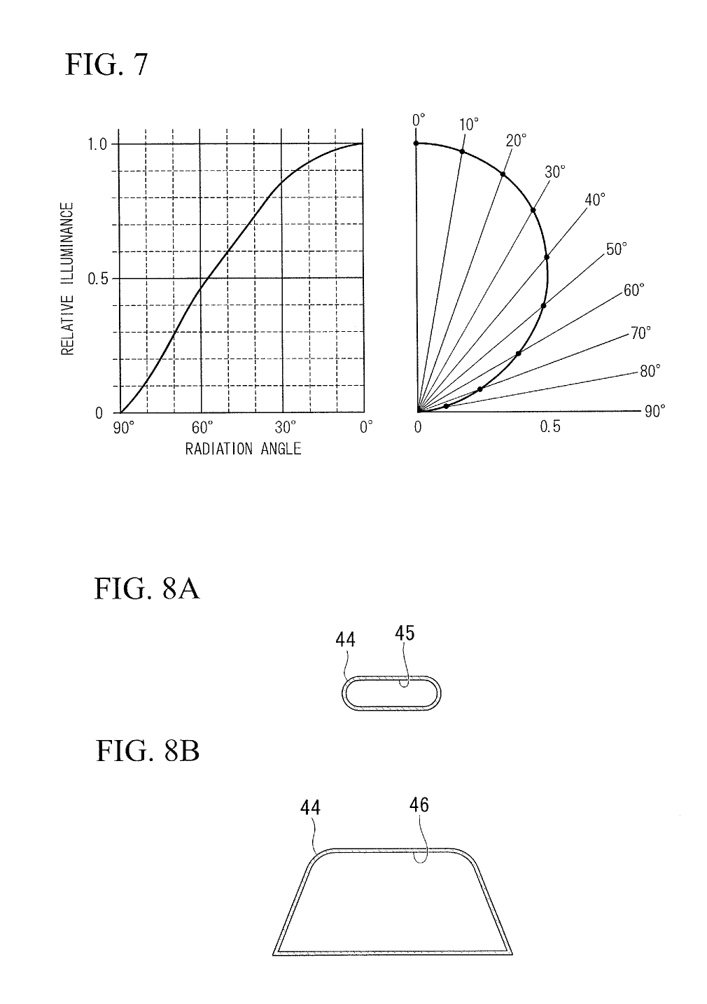

FIG. 7 is a view showing directional characteristics of the LED. Moreover, the directional characteristics of the LED shown in FIG. 7 is disclosed in detail in NPL (Authority: Saving Energy LED/EL Introduction to Illumination Design, Written by Hiroshi Yamazaki, THE NIKKAN KOGYO SHIMBUN,LTD, 2010).

As shown in FIG. 7, compared to the bulb (light bulb) in the related art, in the LED 41, the directivity of the emitted light is high and the diffusibility is low. Specifically, when the relative illuminance in the optical axis Ax (radiation angle is 0) is 1, the relative illuminance is maintained to 0.8 until the radiation angle reaches approximately 30°. Furthermore, if the radiation angle exceeds 30°, the relative illuminance is decreased abruptly.

The light beam guide tube 44 is provided between the LED 41 and the transparent cover 20, surrounds around the optical axis Ax, and is configured to define the illumination region of the fog lamp 1. Specifically, the light beam guide tube 44 is configured so as to define the illumination region of the fog lamp 1 to satisfy predetermined regulations (safety standard, ECE regulation, or the like).

The light beam guide tube 44 includes a light lead-in port 45 provided on the side in which the LED 41 is disposed, and a light lead-out port 46 provided on the side in which the transparent cover 20 is disposed. At least a portion of the light lead-in port 45 and at least a portion of the light lead-out port 46 are disposed so as to overlap each other with each other in the direction in which the optical axis Ax extends. According to this configuration, since the light emitted from the LED 41 has directional characteristics described above, direct light having a large amount of light is introduced to the transparent cover 20 and projected to a predetermined illumination region.

Moreover, the light beam guide tube 44 has a shape in which the opening area gradually increases from the light lead-in port 45 toward the light lead-out port 46 based on the directional characteristics of the LED 41 described above (refer to FIGS. 4 to 6). Furthermore, in the embodiment, in order to satisfy predetermined regulations (in order to eliminate glare for an oncoming vehicle), the light beam guide tube 44 has a shape which gradually increases in size in directions except for the upper portion.

Specifically, it is preferable that the light beam guide tube 44 be designed so as to have a shape which increases in size on both sides within an angle range of ±40° with respect to the optical axis Ax in the left-right direction (vehicle width direction) and be designed so as to have a shape which increases in size within a range of 0° to 40° downward with respect to the optical axis Ax (horizontal surface) in the up-down direction (vehicle height direction).

FIG. 8A is a cross-sectional view taken along A-A of FIG. 6. FIG. 8B is a cross-sectional view taken along B-B of FIG. 6.

The light lead-in port 45 is disposed so as to surround the light-emitting unit 41a (refer to FIG. 4) of the LED 41. In the light-emitting unit 41a according to the embodiment, four rectangular light-emitting regions which perform surface light emission are disposed in series in the left-right direction (horizontal direction and vehicle width direction). Thereby, as shown in FIG. 8A, the light lead-in port 45 has an approximately rectangular shape. On the other hand, as shown in FIG. 8B, the light lead-out port 46 has an approximately trapezoid shape. The light is throttled due to the trapezoid shape, and the illumination region of the fog lamp 1 is determined.

The light beam guide tube 44 includes a position adjustment mechanism 50 which adjusts the position of the light lead-out port 46 (refer to FIGS. 4 to 6). The position adjustment mechanism 50 of the present embodiment is configured to adjust the position in the up-down direction of the light lead-out port 46. A plate spring 51 which is made of an elastically deformable metal is provided below the light beam guide tube 44. The plate spring 51 is fixed to the rear cover 30 by screw members 52. The plate spring 51 is fixed by a pair of screw members 52 with an interval therebetween in the left-right direction, and thus, horizontality of the light beam guide tube 44 is secured.

On the other hand, a female screw 54, which advances and retreats in the axis direction due to rotation of a screw member 53 for position adjustment, is provided above the light beam guide tube 44. The screw member 53 is rotatably supported by a through-hole 34 which penetrates the rear cover 30. Moreover, a flange (not shown) for preventing slipping-out is provided in the opposite side of the screw member 53 in which the head portion of the screw member and the rear cover 30 are interposed. According to the configuration, the female screw 54 advances and retreats in the axis direction of the screw member 53 by rotating the screw member 53 in an arbitrary direction around the axis in the outer portion of the light chamber. Thereby, according to the position of the female screw 54, the light beam guide tube 44 is inclined in the up-down direction while having the fixed position of the plate spring 51 as a supporting point. Therefore, the position of the light lead-out port 46 can be adjusted. Moreover, in the drawings, the light beam guide tube 44 and the LED module 43 are disposed to contact each other. However, in actuality, a minute gap for adjusting the position is formed therebetween.

For example, the light beam guide tube 44 is formed by aluminum material. A light reflection surface 47 is provided in the inner surface side of the light beam guide tube 44. The light reflection surface 47 according to the embodiment is formed by plating processing. Moreover, the light reflection surface 47 may be formed by vapor-deposition processing or by coating light reflective coating agent. For example, as the light reflective coating agent, light reflective coating agent (manufactured from Okitsumo Incorporated) can be appropriately used in which light diffusion properties are improved by inputting fillers having a high reflection to silicone resin, the reflectivity is 98%, and the film thickness is approximately 100 μm.

Furthermore, it is preferable that the inner surface side of the light beam guide tube 44 adopt a configuration in which the light reflectivities of the light reflection surface 47 provided on the upper portion and the light reflection surface 47 provided on the lower portion are different from each other. According to this configuration, the light reflected by the upper light reflection surface 47 and the light reflected by the lower light reflection surface 47 are polarized and interfere with each other, and an occurrence of a striped pattern in the illumination region can be avoided. As means for making the light reflectivities be different from each other, surface processings of the upper light reflection surface 47 and the lower light reflection surface 47 can be different from each other (for example, roughening the surface processing of the upper light reflection surface 47).

Subsequently, an operation due to the fog lamp 1 having the above-described configuration will be described.

If electricity is supplied to the LED 41, the light-emitting unit 41a performs surface light emission. Since the light emitted from the LED 41 has high directivity as shown in FIG. 7, the light does not go around the rear surface side, almost all light is introduced into the light beam guide tube 44 via the light lead-in port 45. Since at least a portion of the light lead-in port 45 and at least a portion of the light lead-out port 46 are disposed so as to overlap each other in the direction in which the optical axis Ax extends, direct light having the maximum amount of light along the optical axis Ax is guided out from the light lead-out port 46. Moreover, since the light beam guide tube 44 has the shape in which the opening area gradually increases from the light lead-in port 45 toward the light lead-out port 46, the light having a large amount of light within a predetermined angle from the optical axis Ax is introduced from the light lead-out port 46 as the direct light without colliding with and being reflected on the inner surface of the light beam guide tube 44. Furthermore, the light having a small amount of light which has a large radiation angle and which collides with the inner surface of the light beam guide tube 44, or the like is also reflected by the light reflection surface 47, and finally, is guided out from the light lead-out port 46.

The direct light and the reflected light which are guided out from the light lead-out port 46 are projected to a predetermined illumination region in the front of the vehicle via the transparent cover 20. The light lead-out port 46 has the shape which defines the illumination region of the fog lamp 1. Specifically, the opening shape of the light lead-out port 46 has a trapezoid shape in which the upper portion is throttled and the lower portion is widened based on predetermined regulations. Therefore, according to the fog lamp 1 of the embodiment, the area in front of the vehicle can be illuminated in a wide width without giving glare to an oncoming vehicle, and thus, it meets the predetermined regulations. Moreover, since the position adjustment mechanism 50 which adjusts the position of the light lead-out port 46 is provided in the fog lamp 1, even after the light beam guide tube 44 is assembled to the inner portion of the light chamber, a fine adjustment in the irradiation direction can be performed by rotating the screw member 53 from the outside.

Furthermore, in the illumination optical system 40 according to the embodiment, the light beam guide tube 44 is provided instead of a lens, light losses due to light passing through the lens do not occur. Moreover, since the direct light is projected, a light path length is shortened, and thus, loss of the amount of light is decreased compared to the related art. Furthermore, due to the light reflection surface 47, the light emitted from the LED 41 can be projected to the irradiation region without waste. Thereby, the fog lamp 1 of high efficiency having improved energy efficiency can be provided.

Moreover, if the energy efficiency increases, even though the design is changed to the LED 41 having low power, since the predetermined required performance is achieved, it can contribute low costs. Furthermore, if the energy efficiency increases, it can also contribute the decrease in the size of the fog lamp 1. The decrease in the size can contribute an increase in the degree of freedom in the design and enlargement of a degree of freedom in a vehicle layout.

In the optical design of the illumination optical system 40, since the light emitting area of the LED 41 is concentrated to be decreased compared to the light source of a bulb type light source in the related art, the irradiation direction and the irradiation range can be easily defined.

Moreover, since the shape of the light beam guide tube 44 is simple and focus alignment is not required as it is in the related art, a degree of freedom in the disposition increases, and the design change is easily implemented. Furthermore, since the design of the shape of the light lead-out port 46 of the light beam guide tube 44 is changed, the irradiation direction, the irradiation range, and the amount of light can be adjusted, and thus, a predetermined required performance can be easily achieved.

Therefore, according to the embodiment, light distribution characteristics satisfying regulations can be performed without the optical design of a complicated lens. Thereby, in the embodiment, since the optical design is easily implemented, a predetermined performance can be achieved, the fog lamp 1 is obtained in which the trial production and experiment are a short period and the burden of expenses can be decreased.

As above, a proper embodiment of the present invention is described referring to the drawings. However, the present invention is not limited to the above-described embodiment. The shapes, the combinations, or the like of each component shown in the above-described embodiment are an example, and various modifications can be performed based on the design requirement or the like within a range which does not depart from the gist of the present invention.

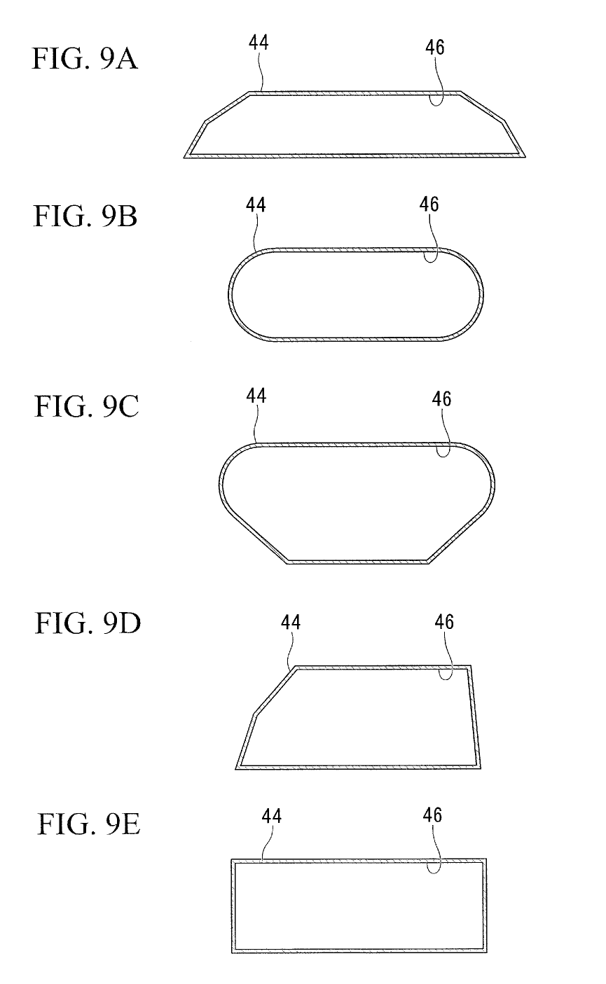

For example, in the embodiment described above, the configuration in which the opening shape of the light lead-out port 46 is a trapezoid shape shown in FIG. 8B is described. However, the present invention is not limited to this configuration, and the configurations shown in FIGS. 9A to 9E may be applied if these satisfy the predetermined regulations.

For example, as shown in FIG. 9A, the light lead-out port 46 may be a shape in which it is more narrow in the up-down direction and more enlarged in the left-right direction than the above-described embodiment. Furthermore, as shown in FIG. 9B, the light lead-out port 46 may have the shape similar to that of the light lead-in port 45. Moreover, as shown in FIG. 9C, in order to illuminate the near front side of the vehicle, the light lead-out port 46 may have a shape in which the opening shape of FIG. 9B is enlarged downward. Furthermore, in order to make light not be reach an oncoming vehicle, as shown in FIG. 9D, the light lead-out port 46 may have a shape in which the shape of an oncoming vehicle side (the center side in a road) is cut. Moreover, as shown in FIG. 9E, the light lead-out port 46 may have a rectangular shape which has short sides in the up-down direction and long sides in the left-right direction. Furthermore, the shape of the light lead-in port 45 may be a rectangular shape similar to the rectangular shape of the light lead-out port corresponding to FIG. 9E. Moreover, corners of the rectangular shape may be round and may have a curvature.

Furthermore, for example, in the embodiment described above, the configuration in which the shape of the light reflection surface 47 of the light beam guide tube 44 is linear as shown in FIG. 5 is described. However, the present invention is not limited to this configuration.

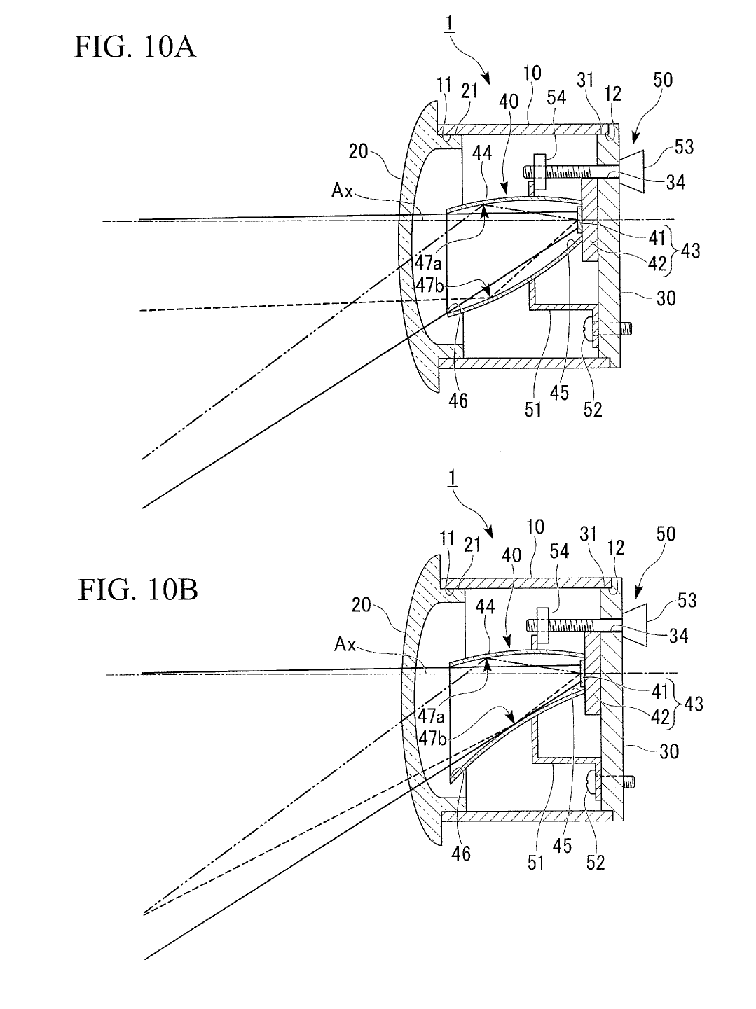

For example, as shown in FIGS. 10A and 10B, a predetermined curvature is formed to the upper side light reflection surface 47a and the lower side light reflection surface 47b, and thus, it is possible to control the diffusion range of the reflected light. Also, this is similarly applied to the left and right light reflection surfaces 47. Moreover, according to FIG. 10A, the upper side light reflection surface 47a has a shape which protrudes upward, and the lower side light reflection surface has a shape which protrudes downward. Furthermore, according to FIG. 10B, the upper side light reflection surface 47a has a shape which protrudes upward, and the lower side light reflection surface also has a shape which protrudes upward.

Furthermore, for example, in the embodiment described above, the configuration in which the optical axis Ax is configured in the direction along the horizontal surface is described. However, the present invention is not limited to this configuration.

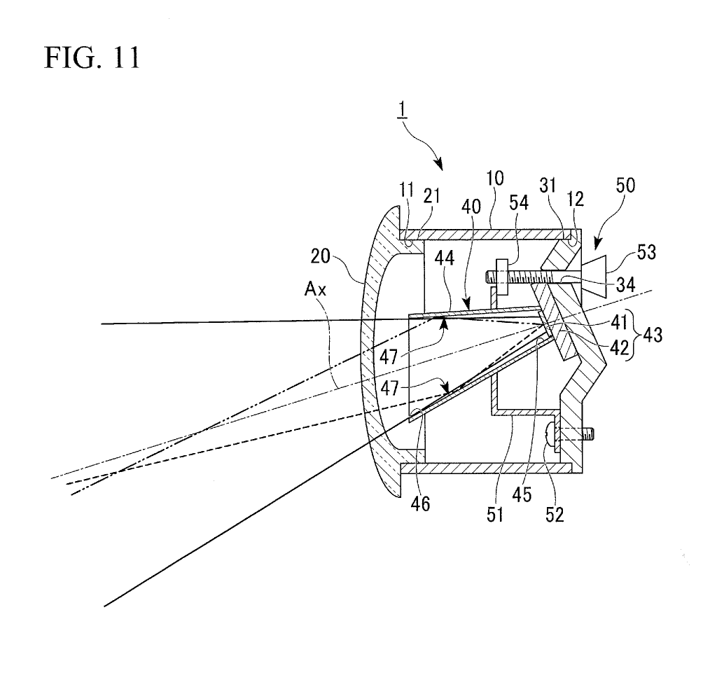

For example, as shown in FIG. 11, the optical axis Ax of the LED 41 may be configured to be directed downward of the direction along the horizontal direction. According to this configuration, since the optical axis Ax of the LED 41 is configured to be directed downward of the direction along the horizontal surface, the optical axis Ax is toward a road surface, the direct light is projected, and thus, the amount of light can be effectively used. Due to the directional characteristics of the LED shown in FIG. 7, it is effective that the optical axis Ax is configured to an angle within a range 0° to 40° downward with respect to the horizontal surface. Moreover, when an aspect of the present invention is applied to the fog lamp, in order to satisfy predetermined regulations, it is most suitable to configure the optical axis Ax to the angle of 2.5° downward.

Furthermore, for example, in the embodiment described above, the configuration in which the transparent cover 20 is circular in the front view is described. However, the present invention is not limited to this configuration. Since the transparent cover 20 only removes water or dust, improvement and differentiation on the appearance can be easily implemented according to the following configurations.

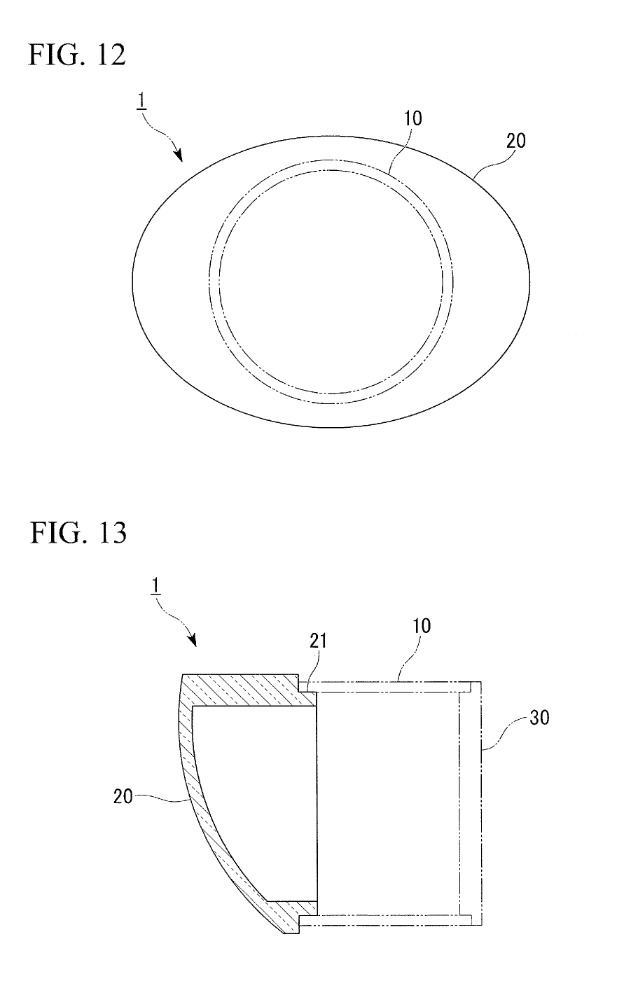

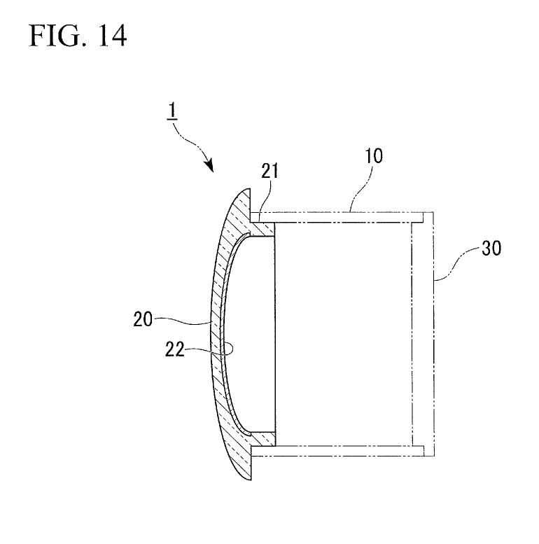

For example, as shown in FIG. 12, the shape of the transparent cover 20 becomes larger than the lamp body 10, and the shape in the front view may be elliptical. Moreover, as shown in FIG. 13, the transparent cover 20 is angled, becomes a slant cover, and thus, may correspond to a curved portion of a bumper. Moreover, as shown in FIG. 14, a vapor-deposition layer 22 is formed on the inner side of the transparent cover 20, and the inner side may be shined. Furthermore, in the vapor-deposition layer 22, metal (for example, indium) particles are disposed in the inner side of the transparent cover 20 like islands in the sea, and the light of the LED 41 can be projected from gaps of the metal particles. Moreover, the outer diameter of the transparent cover 20 may be matched to the outer diameter of the round pipe shaped lamp body 10.

Furthermore, for example, in the embodiment described above, the configuration in which almost all of the light from the LED 41 is introduced to the front by the light beam guide tube 44 is described. However, the present invention is not limited to this configuration. If almost all light from the LED 41 is introduced to the front by the light beam guide tube 44, in the front view, most regions (the outer portion of the light beam guide tube 44) except for the region opposite to the light lead-out port 46 are not bright.

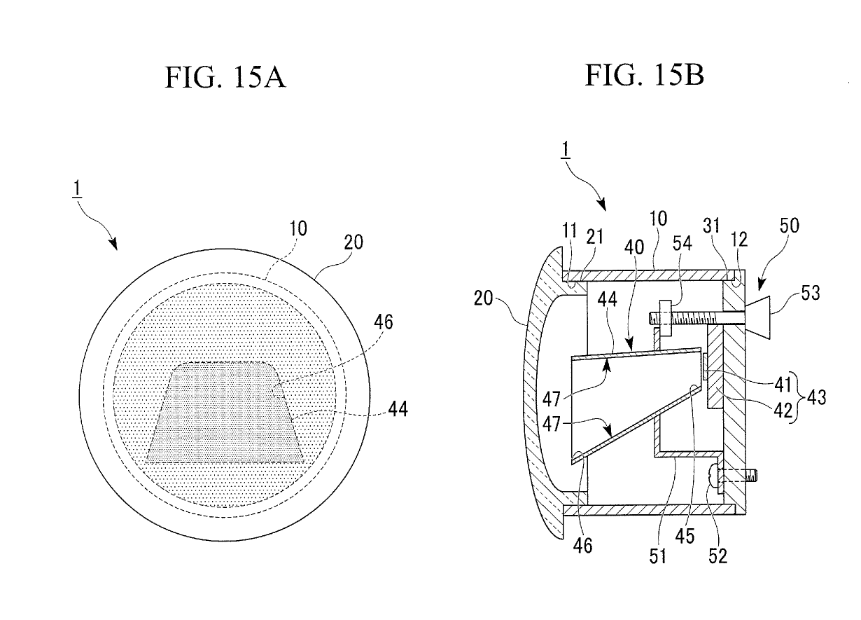

Therefore, as shown in FIG. 15B, the light lead-in port 45 is disposed with a distance from the LED 41, an appropriate amount of light is leaked from the gap, not only the inner portion of the light beam guide tube 44 but also the outer portion thereof is illuminated, and thus, as shown in FIG. 15A, the appearance and conspicuity in the front view can be improved.

Moreover, in FIG. 15A, the intensity of light is shown due to shading of dots.

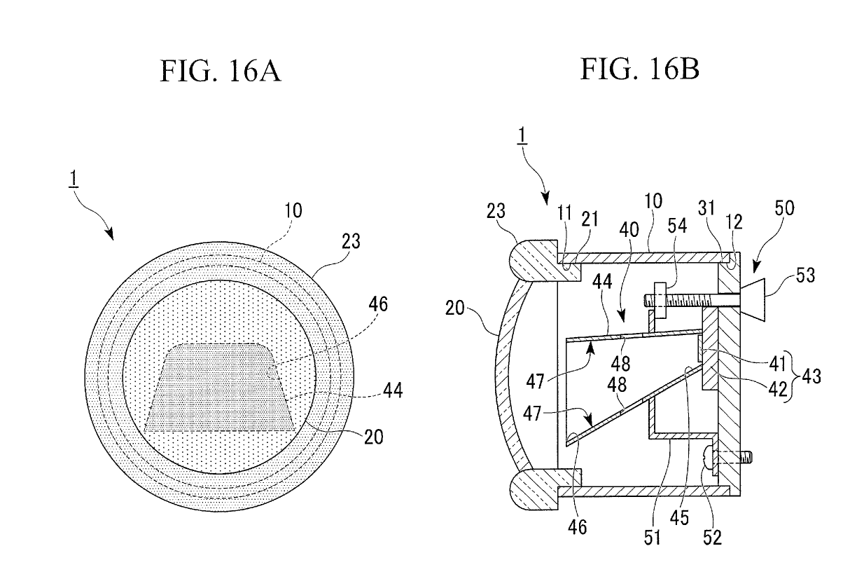

Furthermore, as shown in FIG. 16B, a second light lead-out port 48, which guides a portion of the light introduced to the inner portion via the light lead-in port 45 to the outside, is formed in the body of the light beam guide tube 44, and thus, the light is positively leaked to the outside, and the appearance and conspicuity in the front view can be improved. Moreover, if a ring shaped fluorescent body 23 is provided in the transparent cover 20, ring illumination effects can be simply exhibited. Furthermore, the formation position of the second light lead-out port 48 is adjusted, and thus, light may be positively introduced to the fluorescent body 23.

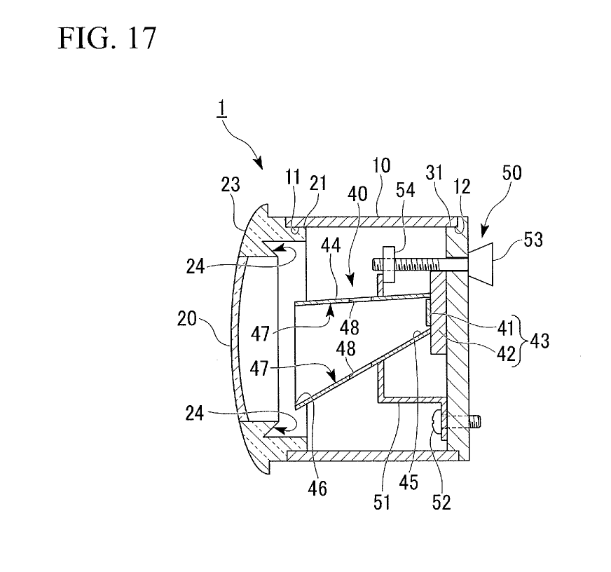

Moreover, as shown FIG. 17, a light reflection surface 24, which positively reflects the light leaked to the outside of the light beam guide tube 44 toward the fluorescent body 23, may be further provided.

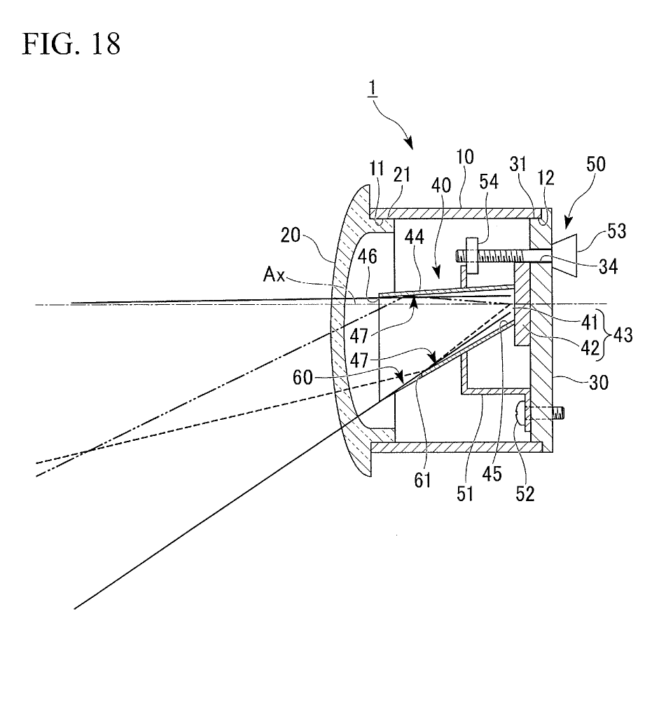

For example, furthermore, as shown in FIG. 18, the shape of the light beam guide tube 44 is considered, and a configuration in which the amount of the light toward the lower side increases may be adopted. Specifically, there may be a configuration including a configuration 61 in which a lower portion 60 of one end of the side (light lead-out port 46 side) in which the transparent cover 20 of the light beam guide tube 44 is disposed is notched at a predetermined distance toward the other end of the side (light lead-in port 45 side) in which the LED 41 is disposed. According to this configuration, since the lower side of the light beam guide tube 44 is relatively shorter with respect to the upper side thereof, the amount of the light toward the lower side can increases while the light toward the upper side is restricted, and thus, the light beam guide can more easily correspond to predetermined regulations.

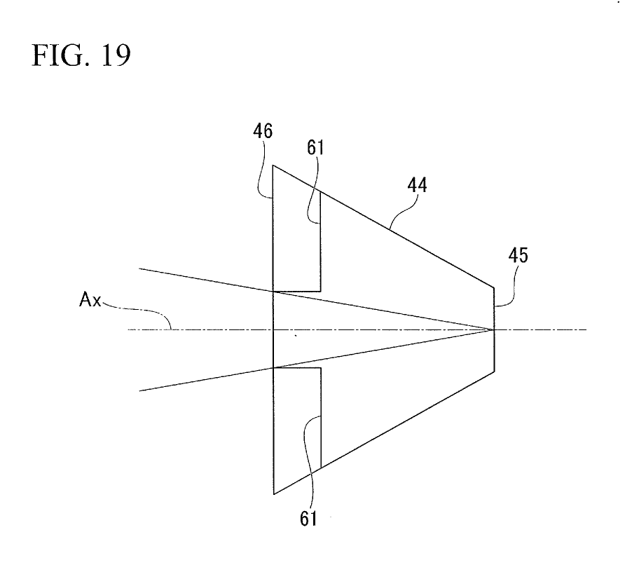

For example, moreover, as shown in FIG. 19, the position in which the notched configuration 61 is provided is considered, and thus, a configuration which meets the predetermined regulations may be adopted. FIG. 19 is a bottom view of the light beam guide tube 44. Specifically, the notched configuration 61 is provided in a pair with an interval therebetween in the left-right direction in which the optical axis Ax is interposed. Moreover, the interval of the notched configurations 61 is configured to be an angle of ±10° or more in the left-right direction with respect to the optical axis Ax. This is because the regulations are limited to a constant amount of light in which the amount of light of the illumination region is within an angle range of ±10° immediately below the front of the vehicle. Therefore, according to this configuration, the predetermined regulations can be satisfied which increases the amount of light in the illumination region in the left-right direction while suppressing the amount of light of the illumination region immediately below the front of the vehicle.

For example, furthermore, in the embodiment described above, a configuration in which the present invention is applied to the fog lamp 1 is described. However, the present invention can be applied to another vehicle lamp, for example, another headlamp.

### INDUSTRIAL APPLICABILITY

According to the present invention, a vehicle headlamp, in which predetermined performance can be achieved due to easiness of an optical design and an expense burden is decreased due to a short period in the trial production and experiments, can be obtained.

Specifically, according an aspect of the present invention, light having a high directivity which is emitted from a semiconductor light-emitting element is guided by the light beam guide tube disposed around the optical axis, and the light is projected to a predetermined illumination region of the front of the vehicle via the transparent cover. The illumination region is defined by the light beam guide tube. In the light beam guide tube, since the shape is simple and focus alignment is not required as it is in the related art, a degree of freedom in the disposition increases, and the design change is easily implemented. Furthermore, since the design of the opening shape of the light beam guide tube is changed, the irradiation direction, the irradiation range, and the amount of light can be adjusted, and thus, a predetermined required performance can be easily achieved.

1. A vehicle headlamp comprising:
a transparent cover;
a lamp body; and
an illumination optical system which is accommodated in the lamp body and projects light to a predetermined illumination region in front of a vehicle via the transparent cover,
wherein the illumination optical system includes a semiconductor light-emitting element in which an optical axis is configured to be directed toward the transparent cover, and a light beam guide tube which is provided between the semiconductor light-emitting element and the transparent cover and defines the illumination region by surrounding the optical axis.

2. The vehicle headlamp according to claim 1,
wherein the light beam guide tube further includes a light lead-in port provided in a side in which the semiconductor light-emitting element is disposed, and a light lead-out port provided in a side in which the transparent cover is disposed, and
at least a portion of the light lead-in port and at least a portion of the light lead-out port are disposed so as to overlap each other in a direction in which the optical axis extends.

3. The vehicle headlamp according to claim 2,
wherein the light beam guide tube includes a shape in which an opening area gradually increases in directions except for the upper portion from the light lead-in port toward the light lead-out port.

4. The vehicle headlamp according to claim 2, further comprising,
a position adjustment mechanism which adjusts a position of the light lead-out port.

5. The vehicle headlamp according to claim 1,
wherein a light reflection surface is provided on an inner surface side of the light beam guide tube.

6. The vehicle headlamp according to claim 5,
wherein the light reflection surface has curvature.

7. The vehicle headlamp according to claim 5,
wherein in the inner surface side of the light beam guide tube, the light reflection surface provided on the upper portion and the light reflection surface provided on the lower portion include light reflectivities which are different from each other.

8. The vehicle headlamp according to claim 1,
wherein the optical axis of the semiconductor light-emitting element is configured to be directed downward with respect to a direction along the horizontal surface.

9. The vehicle headlamp according to claim 1, wherein,
a notched configuration, which is notched at a predetermined distance toward the other end of a side in which the semiconductor light-emitting element is disposed, is provided at a lower portion of one end of a side in which the transparent cover of the light beam guide tube is disposed.

10. The vehicle headlamp according to claim 9,
wherein the notched configuration is provided in a pair with an interval therebetween in a left-right direction in which the optical axis is interposed.

11. The vehicle headlamp according to claim 1,
wherein the light beam guide tube includes a light lead-in port provided in a side in which the semiconductor light-emitting element is disposed, and a light lead-out port provided in a side in which the transparent cover is disposed, and
the light lead-in port is disposed with a distance from the semiconductor light-emitting element.

12. The vehicle headlamp according to claim 1,
wherein the light beam guide tube includes a light lead-in port provided in a side in which the semiconductor light-emitting element is disposed, and a light lead-out port provided in a side in which the transparent cover is disposed, and
a second light lead-out port, which guides a portion of the light introduced to the inner portion via the light lead-in port to the outside, is formed in a body of the light beam guide tube.
